(19) United States
(12) Patent Application Publication
(10) Pub. No.: US 2022/0093003 A1
(43) Pub. Date: Mar. 24, 2022

(54) SECURE CODING ADAPTIVE TRAINING SYSTEM AND METHOD

(71) Applicant: HackEDU, Inc., Santa Monica, CA (US)

(72) Inventors: Jared Ablon, Santa Monica, CA (US); Matthew Koskela, Santa Monica, CA (US)

(21) Appl. No.: 17/483,084

(22) Filed: Sep. 23, 2021

Related U.S. Application Data
(60) Provisional application No. 63/082,123, filed on Sep. 23, 2020.

(51) Int. Cl. G09B 19/00; G06F 21/57; G09B 5/02

(52) U.S. Cl. CPC G09B 19/0053; G06F 2221/033; G09B 5/02; G06F 21/577

(57) ABSTRACT

A secure coding adaptive training system includes a database configured to receive user data including historical training data, proprietary compliance requirement data, coding language relevancy data, performance tracking data, and third party data comprising code vulnerability data, proprietary performance training data, non-proprietary performance training data, and standardized compliance requirement data, an adaptive training engine configured to receive the data from the database, generate adaptive training information from the user data and the third party data, the adaptive training information configured to correlate with criteria associated with a plurality of training lessons, and determine an adaptive training session comprising at least one of the plurality of training lessons, the adaptive training session configured to provide an individualized training plan specific to the user, and a graphical user interface configured to display the adaptive training session to the user and prompt the user to complete the adaptive training session.

### CROSS-REFERENCE TO RELATED APPLICATIONS

This application claims the benefit of U.S. Provisional Application No. 63/082,123, filed on Sep. 23, 2020, which is incorporated by reference herein in its entirety.

### FIELD OF THE INVENTION

The present invention relates generally to a system and method related to secure coding adaptive training.

### BACKGROUND OF THE INVENTION

Conventional software development training is not standardized or optimized currently. As the advent of hacking and security vulnerabilities has been on the rise, and proprietary information of companies and private information of their customers have become more vulnerable, more efficient and relevant security training for software developers is needed.

The background description disclosed anywhere in this patent application includes information that may be useful in understanding the present invention. It is not an admission that any of the information provided herein is prior art or relevant to the presently claimed invention, or that any publication specifically or implicitly referenced is prior art.

### SUMMARY OF THE PREFERRED EMBODIMENTS

In accordance with a first aspect of the present invention, there is provided a secure coding adaptive training system that includes a database configured to receive user data that includes historical training data, proprietary compliance requirement data, coding language relevancy data, performance tracking data, and third party data comprising code vulnerability data, proprietary performance training data, non-proprietary performance training data, and standardized compliance requirement data, an adaptive training engine configured to receive the user data and the third party data from the database, generate adaptive training information from the user data and the third party data, the adaptive training information configured to correlate with criteria associated with a plurality of training lessons, and determine an adaptive training session that includes at least one of the plurality of training lessons, the adaptive training session configured to provide an individualized training plan specific to the user, and a graphical user interface configured to display the adaptive training session to the user and prompt the user to complete the adaptive training session.

The secure coding adaptive training system further includes an impact report engine configured to receive the user data and the third party data from the database, generate impact report information configured to correlate with criteria associated with the user data and the third party data, and determine an impact report from the impact report information, the impact report configured to provide historical user data correlated with the criteria. The graphical user interface is configured to display the impact report to a recipient to identify the effectiveness of the user's training to the recipient. The user may be the recipient.

The criteria may include criticality of vulnerabilities, types of vulnerabilities, a number of times the vulnerabilities have been found, a source of the vulnerability, performance metrics on a training lesson, completion of training lessons, whether the trainee has completed in the subject previously, and previous technologies used.

The user data and/or the third party data may be aggregated over a historical time period.

The code vulnerability data may include static application security testing data, dynamic application security testing data, vulnerability researcher data, and proprietary vulnerability data specific to the user.

A method of adaptively training a user in secure software coding may include receiving user data from a database, the user data configured to track at least one of historical training data, proprietary compliance requirement data, coding language relevancy data, and performance tracking data, receiving non-user data from the database, the non-user data comprising at least one of code vulnerability data, proprietary performance training data, non-proprietary performance training data, and standardized compliance requirement data, generating adaptive training information from the user data and the third party data, the adaptive training information configured to correlate with criteria associated with a plurality of training lessons, and determining an adaptive training session comprising at least one of the plurality of training lessons, the adaptive training session configured to provide an individualized training plan specific to the user.

The method may further include generating impact report information from the user data and the third party data and determine an impact report from the impact report information, the impact report configured to provide historical user data correlated with the criteria. The method may further include displaying the impact report to a recipient to identify the effectiveness of the user's training to the recipient.

The method may further include receiving active training data based on the user's completion of the adaptive training session. The active training data may be used to determine the adaptive training session.

The method may further include correlating the adaptive training information with the criteria associated with the plurality of training lessons.

The method may further include displaying the adaptive training session to the user using a graphical user interface, and prompting the user to complete the adaptive training session.

### BRIEF DESCRIPTION OF THE DRAWINGS

The invention may be more readily understood by referring to the accompanying drawings in which:

FIG. 1 is a block diagram of a secure coding adaptive training system in accordance with a preferred embodiment of the present invention;

FIG. 2 is a block diagram of a secure coding adaptive training system configured to generate an impact report in accordance with a preferred embodiment of the present invention;

FIG. 3 is a block diagram of a secure coding adaptive training system in accordance with a preferred embodiment of the present invention;

FIG. 4 is a screenshot depicting a graphical user interface of a secure coding adaptive training system in accordance with a preferred embodiment of the present invention;

FIG. 5 is a screenshot depicting a graphical user interface of a secure coding adaptive training system in accordance with a preferred embodiment of the present invention;

FIG. 6 is a screenshot depicting a graphical user interface of a secure coding adaptive training system in accordance with a preferred embodiment of the present invention; and

FIG. 7 is a flow diagram of a method of adaptively training a user in secure software coding in accordance with a preferred embodiment of the present invention.

Like numerals refer to like parts throughout the several views of the drawings.

### DETAILED DESCRIPTION OF THE PREFERRED EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are references to the same embodiment; and, such references mean at least one of the embodiments. If a component is not shown in a drawing then this provides support for a negative limitation in the claims stating that that component is “not” present. However, the above statement is not limiting and in another embodiment, the missing component can be included in a claimed embodiment.

Reference in this specification to “one embodiment,” “an embodiment,” “a preferred embodiment” or any other phrase mentioning the word “embodiment” means that a particular feature, structure, or characteristic described in connection with the embodiment is included in at least one embodiment of the-disclosure and also means that any particular feature, structure, or characteristic described in connection with one embodiment can be included in any embodiment or can be omitted or excluded from any embodiment. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others and may be omitted from any embodiment. Furthermore, any particular feature, structure, or characteristic described herein may be optional. Similarly, various requirements are described which may be requirements for some embodiments but not other embodiments. Where appropriate any of the features discussed herein in relation to one aspect or embodiment of the invention may be applied to another aspect or embodiment of the invention. Similarly, where appropriate any of the features discussed herein in relation to one aspect or embodiment of the invention may be optional with respect to and/or omitted from that aspect or embodiment of the invention or any other aspect or embodiment of the invention discussed or disclosed herein.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted.

It will be appreciated that the same thing can be said in more than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” “aft,” “forward,” “inboard,” “outboard” and “below” used herein are merely for ease of description and refer to the orientation of the components as shown in the figures. It should be understood that any orientation of the components described herein is within the scope of the present invention.

In a preferred embodiment of the present invention, functionality is implemented as software executing on a server that is in connection, via a network, with other portions of the system, including databases and external services. The server comprises a computer device capable of receiving input commands, processing data, and outputting the results for the user. Preferably, the server consists of RAM (memory), hard disk, network, central processing unit (CPU). It will be understood and appreciated by those of skill in the art that the server could be replaced with, or augmented by, any number of other computer device types or processing units, including but not limited to a desktop computer, laptop computer, mobile or tablet device, or the like. Similarly, the hard disk could be replaced with any number of computer storage devices, including flash drives, removable media storage devices (CDs, DVDs, etc.), or the like.

The network can consist of any network type, including but not limited to a local area network (LAN), wide area network (WAN), and/or the internet. The server can consist of any computing device or combination thereof, including but not limited to the computing devices described herein, such as a desktop computer, laptop computer, mobile or tablet device, as well as storage devices that may be connected to the network, such as hard drives, flash drives, removable media storage devices, or the like.

The storage devices (e.g., hard disk, another server, a NAS, or other devices known to persons of ordinary skill in the art), are intended to be nonvolatile, computer readable storage media to provide storage of computer-executable instructions, data structures, program modules, and other data for the mobile app, which are executed by CPU/processor (or the corresponding processor of such other components). The various components of the present invention, are stored or recorded on a hard disk or other like storage devices described above, which may be accessed and utilized by a web browser, mobile app, the server (over the network), or any of the peripheral devices described herein. One or more of the modules or steps of the present invention also may be stored or recorded on the server, and transmitted over the network, to be accessed and utilized by a web browser, a mobile app, or any other computing device that may be connected to one or more of the web browser, mobile app, the network, and/or the server.

References to a “database” or to “database table” are intended to encompass any system for storing data and any data structures therein, including relational database management systems and any tables therein, non-relational database management systems, document-oriented databases, NoSQL databases, or any other system for storing data.

Software and web or internet implementations of the present invention could be accomplished with standard programming techniques with logic to accomplish the various steps of the present invention described herein. It should also be noted that the terms “component,” “module,” or “step,” as may be used herein, are intended to encompass implementations using one or more lines of software code, macro instructions, hardware implementations, and/or equipment for receiving manual inputs, as will be well understood and appreciated by those of ordinary skill in the art. Such software code, modules, or elements may be implemented with any programming or scripting language such as C, C++, C#, Java, Cobol, assembler, PERL, Python, PHP, or the like, or macros using Excel or other similar or related applications with various algorithms being implemented with any combination of data structures, objects, processes, routines or other programming elements.

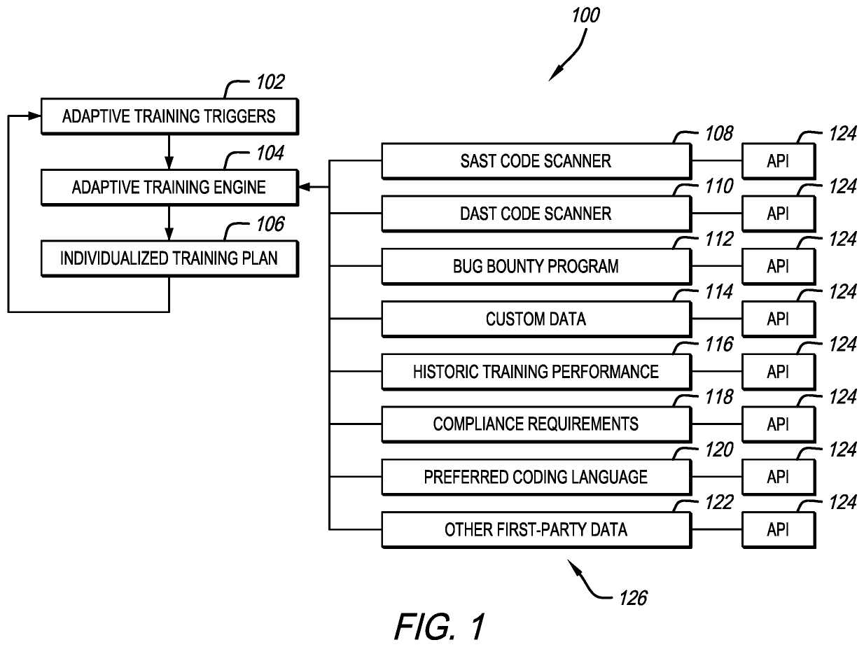

Referring now to the drawings, which are for purposes of illustrating the present invention and not for purposes of limiting the same, the drawings show various embodiments of a secure coding adaptive training system in FIGS. 1-6, and a method of adaptively training a user in secure software coding.

A secure coding adaptive training system in accordance with the present embodiment teaches software developers how to code more securely. It includes both hardware and software that aggregates data including vulnerability data, technology data, libraries used, or other data from one or more sources such as Static Application Security Testing (SAST) tools, Dynamic Application Security Testing (DAST) tools, bug bounty programs, code repositories, issue and project trackers, or other tools and sources.

Referring now to FIG. 1, a block diagram of a secure coding adaptive training system 100 in accordance with a preferred embodiment of the present invention is shown. The system 100 includes adaptive training triggers 102, an adaptive training engine, an individualized training plan 104, a SAST code scanner 106, a DAST code scanner 108, a bug bounty program 110, custom data 112, historic training performance 114, compliance requirements 116, preferred coding language 118, and other first party data 120.

One of ordinary skill in the art would understand that SAST, for example, is an application security testing methodology designed to find security vulnerabilities in an application where the application's source code is available or transparent to persons seeking to exploit potential vulnerabilities in said source code. SAST tools such as the SAST code scanner 106 perform what is referred to colloquially as “white box” testing for this reason and examine the source code of an application for vulnerabilities that could result in security flaws or exposure. SAST, as its name implies, analyzes the static code itself for these vulnerabilities.

DAST is another application security testing methodology designed to find security vulnerabilities in an application while said application is running. Such applications typically do not have source code that is available or transparent to persons seeking to exploit potential vulnerabilities. DAST tools such as the DAST code scanner 108, therefore, perform what is referred to colloquially as “black box” testing for this reason and examine the behavior or response of an application. SAST and DAST tend to uncover different types of vulnerabilities that a person might use to exploit. DAST, as its name implies, analyzes the dynamic runtime behavior of an application.

A bug bounty program such as the bug bounty program 110 is a program designed to expose vulnerabilities in existing software code. A bug bounty program typically includes an offer from companies, organizations, software developers, or websites to receive compensation or recognition for identifying and reporting bugs in software. In the particular application described herein, data from a bug bounty source will provide identification of security vulnerabilities and potential ways in which a third party might exploit a particular software application. In practice, a vulnerability researcher reports a vulnerability in an application via the company's bug bounty program.

The custom data 112 includes proprietary data such as proprietary compliance requirement data configured to identify vulnerabilities in a company's proprietary code or application. The historic training performance 114 tracks a user's historic performance of training sessions. For example, the historic training performance 114 tracks the specific training sessions completed by the user. The historic training performance 114 may also track historic training sessions completed by users other than the first-party user. The performance information may include whether the user/users passed or failed the training lesson, or a numbered/lettered score associated with the training lesson.

The compliance requirements 116 preferably include company or proprietary requirements for their coding employees. For example, a company may provide software or application products to third parties as part of its business model or may utilize software or application products of others in its own business activities. In these scenarios, it may be advantageous for a company to require particular training for its coding employees. As an example, a company may have internal or external compliance requirements that make certain training lessons critical for the security of their software, applications, or proprietary data of the company or private information of a company's customers. Alternatively, or in combination with the above, a company may have a variety of other reasons why particular vulnerability training is necessary for its coding employees. The adaptive training engine 104 includes the company's requirements in connection with making a determination about what training lessons to provide in an individualized training plan 106. For example, the compliance requirements 116 may include training lessons configured to provide vulnerability training for the payment card industry.

The preferred coding languages 120 preferably include those coding languages specified by a company for its coding employees, but may also include those coding languages only that the user knows. For example, if a user only knows Java or HTML, then the adaptive training engine 104 will exclude training lessons for C++.

The other first-party data 122 may include other information specified by the user or the user's company. For example, the other first-party data 122 includes a level of proficiency in a coding language or a level of proficiency as a coding professional. The other first-party data 122 preferably includes data relating to hacking challenges in which the user has participated.

Each of the SAST code scanner 106, the DAST code scanner 108, the bug bounty program 110, the custom data 112, the historic training performance 114, the compliance requirements 116, the preferred coding language 118, and other first party data 120 are data sources 126 that preferably are combined to provide data for the adaptive training engine 104. One of ordinary skill in the art would understand that the data sources 126 are not exhaustive but rather, give examples of the types of data provided to the adaptive training engine 104 in order to train the user in vulnerabilities of particular software, coding languages, and the like. The data sources 126 are preferably aggregated and provided to the adaptive training engine 104. Depicted to the right of each of the data sources 126 is an API 124 (i.e., Application Programming Interface) that is configured to receive push or pull data from a first-party or third-party data source. Alternatively, the API 124 may be a command line tool configured to receive and store the data on a database. The SAST code scanner 108, the DAST code scanner 110, the bug bounty program 112, and the custom data 114 are configured to provide vulnerability data to the adaptive training engine 104 via their respective APIs 124.

The adaptive training triggers 102 are configured to start or execute the adaptive training engine 104. The triggers 102 preferably include an automatic trigger at the beginning of each training session, and manually via a graphical user interface (GUI). In another embodiment, the triggers 102 preferably include a periodic implementation of the adaptive training engine 104.

The adaptive training engine 104 preferably is an API connected to various online services or other APIs to obtain a variety of data from the data sources 126. The data sources 126 are chosen to provide user-specific data (e.g., first-party data) and third party data (e.g., aggregated or non-aggregated data from users or data sources 126 other than the user, or agnostic to the user). The adaptive training engine 104 receives data from the data sources 126 and generates an individualized training plan 106 that is preferably specified for a particular trainee so that any training history or performance, coding languages known, and compliance requirements of the trainee's industry, organization, or company, are taken into account. As described herein, the adaptive training engine 104 also receives vulnerability data from the SAST code scanner 108, the DAST code scanner 110, the bug bounty program 112, and the custom data 114. These data are updated periodically with the latest vulnerabilities from a variety of data sources in order to ensure that the trainee is being trained with the most current vulnerabilities. These vulnerabilities are compared against the first-party user data such that performance and history of a user's training are taken into account. For example, a user working for a company may require particularized training for vulnerabilities in connection with the company's specific software or applications. The software and/or applications may relate to specific coding languages, for example, C++ or Java. The first-party user data may indicate that the trainee has already completed vulnerability training for vulnerabilities in the C++ coding language in connection with the company's software. Thus, the adaptive training engine 104 may determine that the particular training lesson is no longer needed. In addition, the first party user data may indicate that the trainee has also completed vulnerability training for vulnerabilities in Java coding language in connection with the company's software. However, the user may have completed that particular lesson with a non-passing score. Thus, the adaptive training engine 104 may determine that the particular lesson is required to be repeated for that particular user. The adaptive training engine 104 may also determine, for example, that a particular training lesson is needed to be repeated not for performance concerns, but because the training lesson has been updated with current vulnerabilities that are critical to the company's security. Thus, the adaptive training engine 104 will specify that the user must repeat the particular training lesson with those particular updates.

The adaptive training engine 104 generates an individualized training plan 106. The examples described above illustrate how the adaptive training engine 104 determines what particular training lessons are required. The individualized training plan 106 preferably is a comprehensive set of training lessons chosen by the adaptive training engine 104. For example, if the adaptive training engine 104 is configured to have access to 70 training lessons, the adaptive training engine 104 may determine that 4 of those 70 training lessons are required to be completed by a particular user based on the first party and third party data.

Once the training exercise or assignment is completed, the training data is fed back into the Adaptive Training Engine for use during the next session for that particular trainee. FIG. 1 depicts the feedback triggering the adaptive training triggers 102 to start the adaptive training engine 104 over again.

Preferably the adaptive training engine 104 dynamically updates its data sources 126 (beyond just the particular trainee's training data) so that the most current information from various data sources 126 is used to create the most relevant training platform for the trainee.

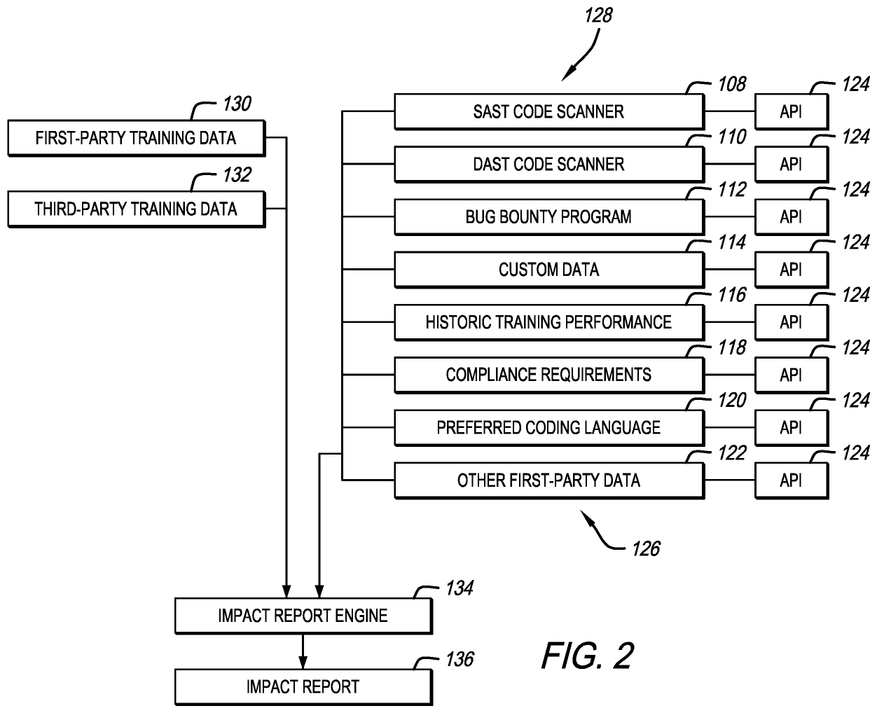

Referring now to FIG. 2, a block diagram of a secure coding adaptive training system 128 configured to generate an impact report 136 in accordance with a preferred embodiment of the present invention is depicted. The system 128 includes first-party training data 130, third-party training data 132, an impact report engine 134, and an impact report 136, in addition to like elements already depicted and described in FIG. 1 above.

The impact report 136 is configured to provide a mapping and display of vulnerability data correlated to actual training being conducted on a particular user or group of users. The system 128 in connection with this embodiment is a secure coding training platform that teaches software developers how to code more securely. The adaptive training engine 104 aggregates data including vulnerability data from one or more sources such as the SAST and DAST code scanner tools 108, 110, the bug bounty program 112, the custom data 112, the historic training performance 114, the compliance requirements 116, the preferred coding language 118, and other first party data 120. The other first-party data 120 may include data from a trainee's software they wrote personally, their organization or company's software or applications, or other software, public or private, that has been scanned and evaluated for vulnerabilities. The data sources 126 along with first-party training data 130 (proprietary data generated by the adaptive training engine 104) and third-party training data 132 (obtained from third-party sources) is used to develop a report or set of reports that show a mapping of the training data and the aggregated data (e.g., from the data sources 126) using an algorithm encapsulated in the impact report engine 134. The algorithm for creating an impact report 136 from the data may include criticality of vulnerabilities, types of vulnerabilities, a number of times the vulnerabilities have been found, a source of the vulnerability, performance metrics on a training lesson, completion of training lessons, whether the trainee has completed in the subject previously, technologies used, and a variety of other metrics or criteria. The impact report engine 134 may utilize artificial intelligence (AI), machine learning, or other programming methodologies to determine the impact report 136.

The impact report 136 may include graphs, diagrams, and/or raw data. As described herein, the data sources 126 may provide data pulled or pushed into the platform and preferably is updated on scheduled time intervals or continuously such that the impact report 136 is updated in near real-time to reflect the latest threats and relevant vulnerabilities and how that maps to particular trainees. The impact report 136 may also include some or all of a trainee's first-party training data 130, such as time spent on a lesson, when training lessons were completed, which training lessons were completed, and the trainee's performance on the training lesson.

Taking in relevant and timely vulnerability and technology data and mapping that with trainee data shows the impact from training or other changes of behavior by correlating it. Viewing relevant and timely vulnerabilities with relevant training progress will show the effectiveness of the training and is utilized to improve the training. In addition, continuous updates of the data sources 126, first-party training data 130, and third-party training data 132, means that the impact report 136 is dynamic and always reflecting the effectiveness of the training. The impact report 136 will help reduce vulnerabilities in software by focusing on what is relevant and the exact issues that software developers are facing.

The first-party training data 130 preferably is historical data captured by the adaptive training engine 104 and stored on a database. The third-party training data 132 preferably is training data obtained from third-party sources such as SAAS/DAST code scanner tools 108, 110 and learning management systems (LMS) such as Cornerstone LMS, as one example. One of ordinary skill in the art would understand that an LMS is a software application that facilitates administration, tracking, training programs, and learning and development programs for third parties. In this embodiment, the third-party training data 132 is training data obtained from these third-party data sources.

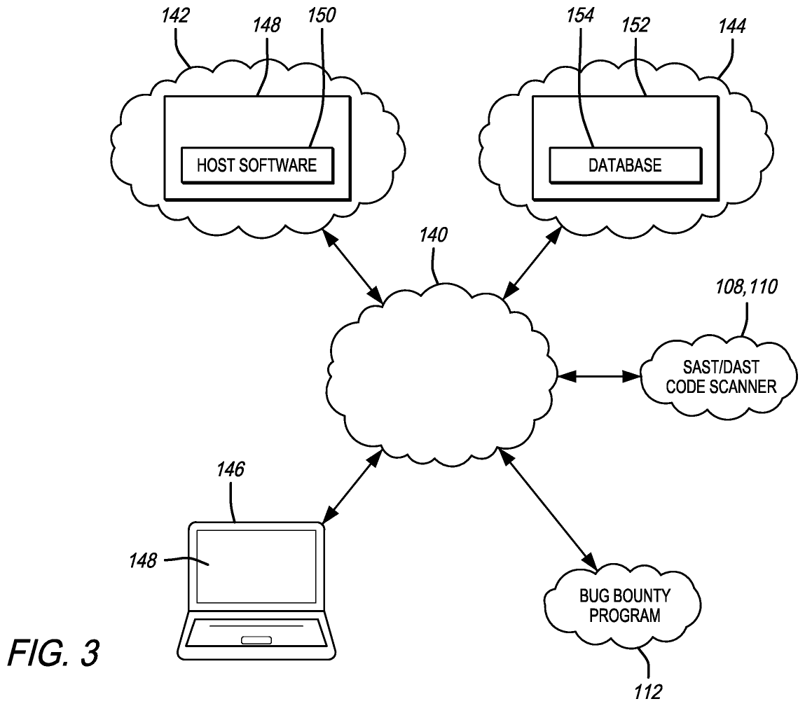

Referring now to FIG. 3, a block diagram of a secure coding adaptive training system 138 in accordance with a preferred embodiment of the present invention is depicted. FIG. 3 illustrates an exemplary implementation of the system 138 using cloud-based computing techniques. The system 138 includes a web 140, a first cloud 142, a second cloud 144, a SAST/DAST code scanner 108, 110, a bug bounty program 112, and a device 146.

The web 140 is the World Wide Web or Internet. The first cloud 142 is a cloud-based computing system configured to host applications and/or software. As shown in FIG. 3, the first cloud 142 includes a first server 148 and host software 150. In this embodiment, the host software 150 is the adaptive training engine 104 and/or the impact report engine 134. The second cloud 144 is a cloud-based computing system configured to host applications and/or software. The second cloud 144 includes a second server 152 and a database 154. The database 154 is utilized to pull/push data from the data sources 126 via APIs 124.

The web 140 facilitates the ability for the host software 150 to obtain data from the data sources 126 and/or data stored on the database 154. The host software 150, in an embodiment, utilizes the data from the database 154 to run the algorithms associated with the adaptive training engine 104 and/or the impact report engine 134. The SAST/DAST code scanners 108, 110 are accessible via the web 140 and the database 154 may be configured to receive push/pull data from the SAST/DAST code scanners 108, 110. So, too, the bug bounty program 112 are accessible via the web 140 and the database 154 may be configured receive push/pull data from the bug bounty program 112. While not shown, any of the other data sources 126 may be configured to be accessible via the web 140 such that the database 154 may receive push/pull data from any of the data sources 126.

The device 146 includes a graphical user interface 148 configured to display information to a user. The device 146 is connected to the web 140 and is configured to obtain data or information from the host software 150 and the database 154 in accordance with the system 138 and accompanying methods as described herein.

One of ordinary skill in the art would understand that the system 138 is exemplary and that a variety of other typologies or computing methodologies may be utilized without departing from the scope of the present invention. For example, the system 138 may be implemented in a non-cloud-based environment, or partially in a cloud-based environment and a non-cloud-based environment.

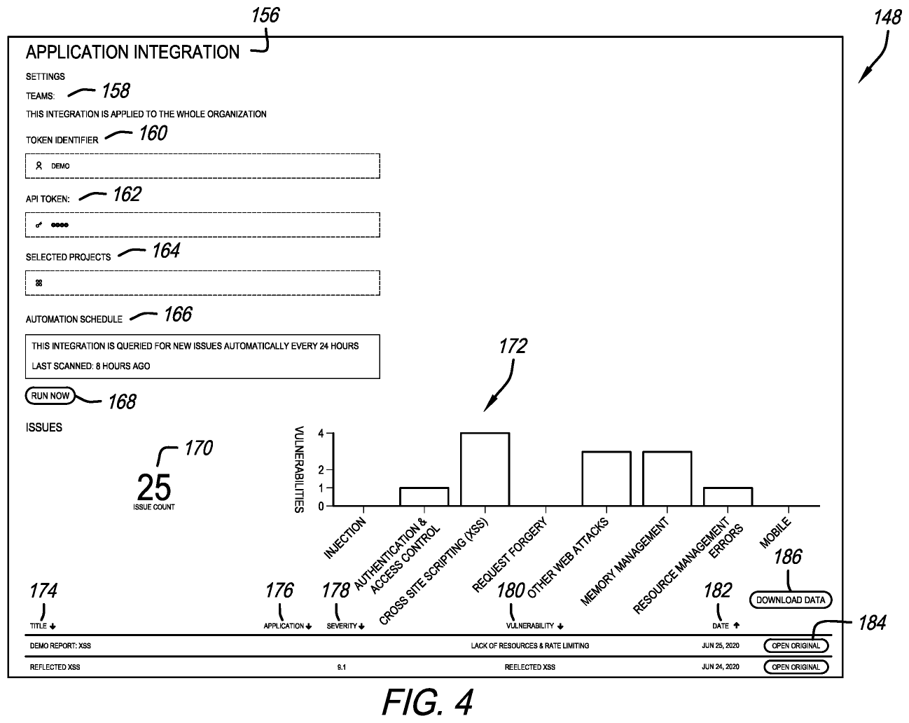

Referring now to FIG. 4, a screenshot depicting a GUI 148 of a secure coding adaptive training system 100, 128, 138 in accordance with a preferred embodiment of the present invention is shown. The GUI 148 includes an application title 156, a scope indicator 158, a token identifier 160, an API token 162, selected projects field 164, an automation schedule 166, a run now button 168, an issue count 170, a vulnerability data chart 172, a title field 174, an application identifier 176, a severity score field 178, a vulnerability identifier 180, a date field 182, an open original button 184, and a download data button 184.

The application title 156 depicted in FIG. 4 reads “Application Integration.” The application title 156 is an identification of the particular application, which in this embodiment is to integrate data in connection with a particular team and project. For example, the application title 156 is Hackerone, a third-party data source 126. The scope indicator 158 is an identification of the users and/or teams on which the integration will be applied. For example, in FIG. 4, the scope indicator 158 reads “Teams: This integration is applied to the whole organization.” Thus, the integration will be applied to the entire organization specified by the application. The token identifier 160 is an identification field showing the integration data to be applied to the organization or user and utilized to cache information and provide it to the application. The API token 162 is an identification field showing the API token utilized in token-based authentication to allow an application to access an API. The selected projects field 164 identifies the internal project name and is utilized to identify and keep track of the integration project. The automation schedule 166 identifies whether and when an automated integration will occur, and under what periodic timeframe the integration will occur. For example, FIG. 4 reads “This integration is queried for new issues automatically every 24 hours.” The automation schedule 166 also provides information about when the last scan occurred which, in FIG. 4, reads “Last Scanned: 8 hours ago.” The run now button 168 is configured to allow a user to manually scan for new issues rather than wait for an automated scheduled scan to occur. The issue count 170 is an identification of how many issues were identified in the integration of data for the particular project.

The vulnerability data chart 172 provides a graphical illustration of the vulnerabilities in chart format. The vulnerabilities are scored based on their severity and depicted graphically for the user. The x-axis of the vulnerability data chart 172 lists vulnerabilities such as injection, authentication and access control, cross site scripting (XSS), request forgery, other web attacks, memory management, resource management errors, and mobile. One of ordinary skill in the art would understand these vulnerabilities exist in a variety of software and applications and are relevant to train the user in secure coding. As one of ordinary skill in the art would recognize, vulnerabilities exist that are not depicted in FIG. 4.

On the bottom of FIG. 4 there appears a description of each vulnerability in connection with the project and the ability to open a detailed report concerning the vulnerability. The title field 174 identifies the title of the report itself. The application identifier 176 identifies the application associated with the selected projects 164. The severity score field 178 identifies the severity of a vulnerability. In an embodiment, the severity of a vulnerability is given a numbered value to signify its severity as compared with other vulnerabilities. In FIG. 4, the severity of “Reflected XSS on API” is given a severity score of 9.1. The vulnerability identifier 180 identifies the name of the particular vulnerability. The date field 182 identifies the date the report was generated. The open original button 184 permits a user to open a detailed report showing the vulnerability and additional information concerning the vulnerability. The download data button 184 permits a user to download additional data on vulnerabilities. In an embodiment, the download data button 184 obtains data from the data sources 126 stored on the database 154. One of ordinary skill in the art would understand that the GUI 148 depicted in FIG. 4 may be modified or display information differently to achieve the results desired without departing from the scope of the present invention.

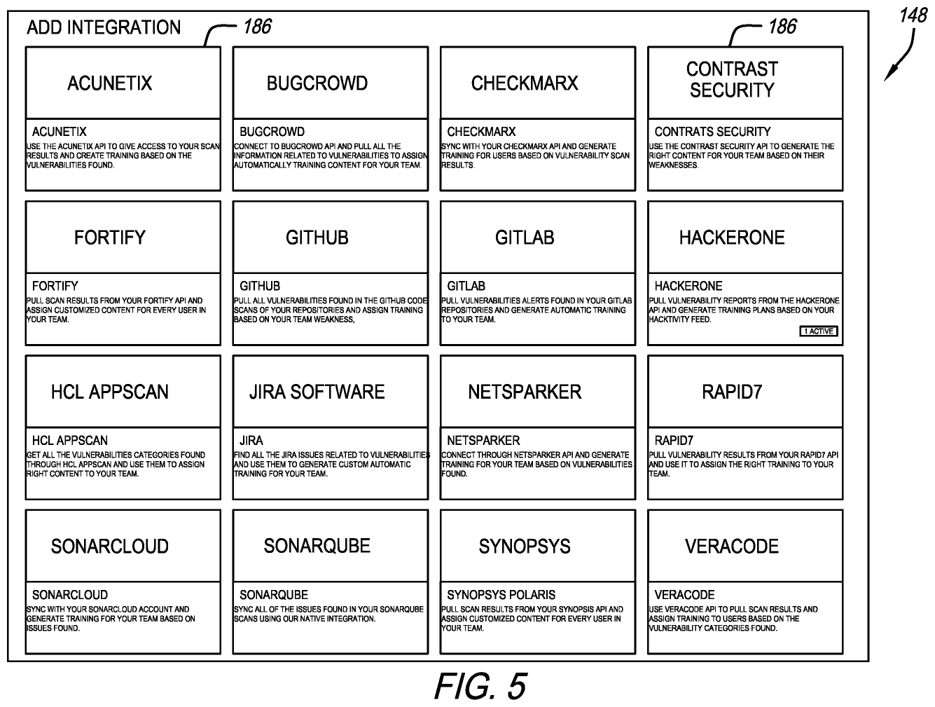

Referring now to FIG. 5, a screenshot depicting a GUI 148 of a secure coding adaptive training system 100, 128, 138 in accordance with a preferred embodiment of the present invention is shown. The GUI 148 shown in FIG. 5 permits a user to graphically view each integration available from third-party sources. The GUI 148 includes icons 186 to allow the user to select the particular third-party data source 126 for integration. For example, FIG. 5 identifies Acunetix, Bugcrowd, Checkmarx, Contrast Security, Fortify, Github, Gitlab, Hackerone, HCL Appscan, JIRA Software, Netsparker, Rapid7, Sonarcloud, Sonarqube, Synopsis, and Veracode. Each icon 186 provides a description to the user to understand what integrating the particular third-party data source 126 will provide. For example, the icon 186 for Acunetix reads “Use the Acunetix API to give access to your scan results and create training based on the vulnerabilities found.” One of ordinary skill in the art would understand that the GUI 148 depicted in FIG. 5 may be modified or display information differently to achieve the results desired without departing from the scope of the present invention.

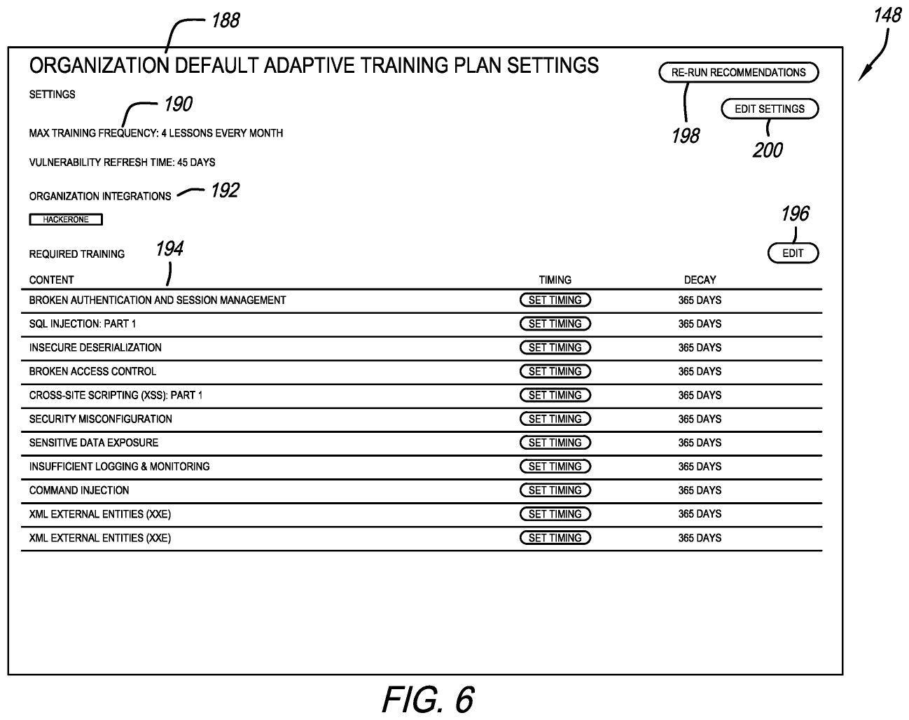

Referring now to FIG. 6, a screenshot depicting a GUI 148 of a secure coding adaptive training system 100, 128, 138 in accordance with a preferred embodiment of the present invention is shown. The GUI 148 of FIG. 6 shows exemplary settings for a “default” adaptive training plan 106. The GUI 148 includes an application settings title 188, a training frequency identifier 190, an organizational integration identifier 192, a content list 194, an edit button 196, a re-run recommendations button 198, and an edit settings button 200.

The application settings title 188 identifies the application title to identify to the user the specific organization settings. The training frequency identifier 190 identifies a maximum training frequency, for example, “4 Lessons Every Month,” and a vulnerability refresh time, for example, “45 Days.” These fields may be modified depending on the needs of the company or user. The organizational integration identifier 192 provides the user with which integration (i.e., see FIG. 5 for listing) is being specified. The content list 194 shows the user which training lessons are being required by the company or user (e.g., the individualized training plan 106). The edit button 196 permits the user to add or delete training programs manually. The re-run recommendations button 198 triggers the adaptive training engine 104 to re-generate the individualized training plan 106. The edit settings button 200 permits the user to edit the training frequency identifier 190 and the organizational integration identifier 192. One of ordinary skill in the art would understand that the GUI 148 depicted in FIG. 6 may be modified or display information differently to achieve the results desired without departing from the scope of the present invention.

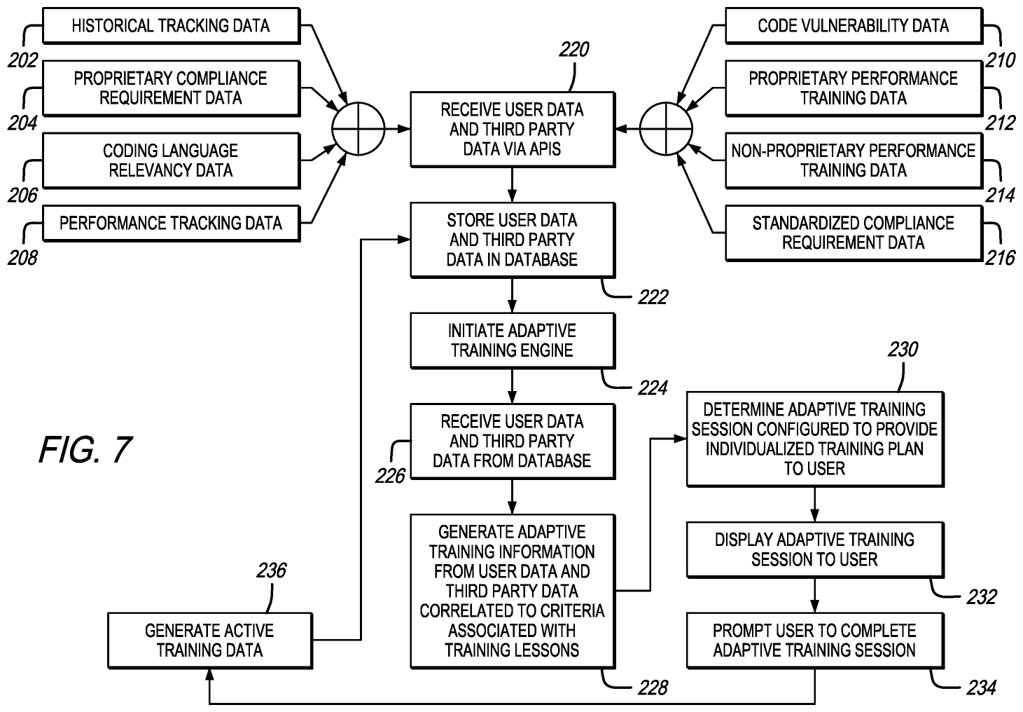

Referring now to FIG. 7, a flow diagram of a method of adaptively training a user in secure software coding in accordance with a preferred embodiment of the present invention is depicted. FIG. 7 includes user data (e.g., first party data 120) such as historical tracking data 202, proprietary compliance requirement data 204, coding language relevancy data 206, and performance tracking data 208. One of ordinary skill in the art would understand that other data may be provided as user data.

FIG. 7 also includes third-party data (e.g., third-party data sources 126) such as code vulnerability data 210, proprietary performance training data 212, non-proprietary performance training data 214, and standardized compliance requirement data 216. One of ordinary skill in the art would understand that other data may be provided as third-party data.

At Step 220, user data and third-party data are received via APIs 124. As described herein the user data generally refers to data from data sources 126 concerning the user or user group for which an individualized training plan 106 is to be generated. The third-party data general refers to data from third-party data sources 126.

At Step 222, the user data and the third-party data is stored in the database 154. As described herein the database 154 may be implemented utilizing cloud-based computing technology or through other conventional means such as standalone computing devices and/or accessible through a local network.

At Step 224, the adaptive training engine 104 is initiated. As described herein, the adaptive training engine 104 may be triggered/initiated by the adaptive training triggers 102. In another embodiment, the impact report engine 134 may be initiated/triggered.

At Step 226, the user data and the third party data are received from the database 154. As described herein, the adaptive training engine 104 may receive the data from the database 154. The impact report engine 134 may also receive the data from the database 154 in another embodiment.

At Step 228, adaptive training information is generated from user data and third-party data correlated to criteria associated with training lessons. As described herein, the training lessons are correlated with certain vulnerability data such as those shown in the vulnerability data chart 172. The vulnerability data may be a criteria associated with particular training lessons; for example, an “injection” vulnerability is criteria associated with a training lesson configured to train a software developer on typical or recent injection vulnerabilities. Other criteria include those described herein, including any and all user data and third-party data and metrics associated with those data. For example, another criteria is performance metrics associated with particular training lessons.

At Step 230, an adaptive training session is determined. The adaptive training session is configured to provide the individualized training plan 106 to the user or user group.

At Step 232, the adaptive training session is displayed to the user. At Step 234, the user is prompted via GUI 148 to complete the adaptive training session. In another embodiment, the impact report 136 is displayed to the user.

At Step 234, active training data (e.g., first-party data or user data) is generated and provided to the database 154, where it is stored for retrieval by the adaptive training engine 104 and/or the impact report engine 134.

One of ordinary skill in the art would understand that variations of the methods disclosed herein are possible without departing from the scope of the present invention.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description of the Preferred Embodiments using the singular or plural number may also include the plural or singular number respectively. The word “or” in reference to a list of two or more items, covers all of the following interpretations of the word: any of the items in the list, all of the items in the list, and any combination of the items in the list.

The above-detailed description of embodiments of the disclosure is not intended to be exhaustive or to limit the teachings to the precise form disclosed above. While specific embodiments of and examples for the disclosure are described above for illustrative purposes, various equivalent modifications are possible within the scope of the disclosure, as those skilled in the relevant art will recognize. Further, any specific numbers noted herein are only examples: alternative implementations may employ differing values, measurements or ranges.

Although the operations of any method(s) disclosed or described herein either explicitly or implicitly are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

The teachings of the disclosure provided herein can be applied to other systems, not necessarily the system described above. The elements and acts of the various embodiments described above can be combined to provide further embodiments. Any measurements or dimensions described or used herein are merely exemplary and not a limitation on the present invention. Other measurements or dimensions are within the scope of the invention.

Any patents and applications and other references noted above, including any that may be listed in accompanying filing papers, are incorporated herein by reference in their entirety. Aspects of the disclosure can be modified, if necessary, to employ the systems, functions, and concepts of the various references described above to provide yet further embodiments of the disclosure.

These and other changes can be made to the disclosure in light of the above Detailed Description of the Preferred Embodiments. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features or aspects of the disclosure with which that terminology is associated. In general, the terms used in the following claims should not be construed to limit the disclosures to the specific embodiments disclosed in the specification unless the above Detailed Description of the Preferred Embodiments section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. § 112, ¶6, other aspects may likewise be embodied as a means-plus-function claim, or in other forms, such as being embodied in a computer-readable medium. (Any claims intended to be treated under 35 U.S.C. § 112, ¶6 will include the words “means for”). Accordingly, the applicant reserves the right to add additional claims after filing the application to pursue such additional claim forms for other aspects of the disclosure.

Accordingly, although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

What is claimed is:

1. A secure coding adaptive training system, the secure coding adaptive training system comprising:
a database configured to receive user data comprising historical training data, proprietary compliance requirement data, coding language relevancy data, performance tracking data, and third party data comprising code vulnerability data, proprietary performance training data, non-proprietary performance training data, and standardized compliance requirement data,
an adaptive training engine configured to receive the user data and the third party data from the database, generate adaptive training information from the user data and the third party data, the adaptive training information configured to correlate with criteria associated with a plurality of training lessons, and determine an adaptive training session comprising at least one of the plurality of training lessons, the adaptive training session configured to provide an individualized training plan specific to the user, and
a graphical user interface configured to display the adaptive training session to the user and prompt the user to complete the adaptive training session.

2. The secure coding adaptive training system of claim 1 further comprising an impact report engine configured to receive the user data and the third party data from the database, generate impact report information configured to correlate with criteria associated with the user data and the third party data, and determine an impact report from the impact report information, the impact report configured to provide historical user data correlated with the criteria, wherein the graphical user interface is configured to display the impact report to a recipient to identify the effectiveness of the user's training to the recipient.

3. The secure coding adaptive training system of claim 2 wherein the user is the recipient.

4. The secure coding adaptive training system of claim 1 wherein the criteria include criticality of vulnerabilities, types of vulnerabilities, a number of times the vulnerabilities have been found, a source of the vulnerability, performance metrics on a training lesson, completion of training lessons, whether the trainee has completed in the subject previously, and previous technologies used.

5. The secure coding adaptive training system of claim 1 wherein the user data is aggregated over a historical time period.

6. The secure coding adaptive training system of claim 1 wherein the third party data is aggregated over a historical time period.

7. The secure coding adaptive training system of claim 1 wherein the code vulnerability data comprises at least one of static application security testing data, dynamic application security testing data, vulnerability researcher data, and proprietary vulnerability data specific to the user.

8. A method of adaptively training a user in secure software coding, the method comprising the steps of:
receiving user data from a database, the user data configured to track at least one of historical training data, proprietary compliance requirement data, coding language relevancy data, and performance tracking data,
receiving non-user data from the database, the non-user data comprising at least one of code vulnerability data, proprietary performance training data, non-proprietary performance training data, and standardized compliance requirement data,
generating adaptive training information from the user data and the third party data, the adaptive training information configured to correlate with criteria associated with a plurality of training lessons, and
determining an adaptive training session comprising at least one of the plurality of training lessons, the adaptive training session configured to provide an individualized training plan specific to the user.

9. The method of claim 8, the method further comprising the steps of generating impact report information from the user data and the third party data and determine an impact report from the impact report information, the impact report configured to provide historical user data correlated with the criteria.

10. The method of claim 9, the method further comprising the steps of displaying the impact report to a recipient to identify the effectiveness of the user's training to the recipient.

11. The method of claim 8 wherein the criteria include criticality of vulnerabilities, types of vulnerabilities, a number of times the vulnerabilities have been found, a source of the vulnerability, performance metrics on a training lesson, completion of training lessons, whether the trainee has completed in the subject previously, and previous technologies used.

12. The method of claim 8, the method further comprising the step of receiving active training data based on the user's completion of the adaptive training session.

13. The method of claim 12 wherein the active training data is used to determine the adaptive training session.

14. The method of claim 8, the method further comprising the step of correlating the adaptive training information with the criteria associated with the plurality of training lessons.

15. The method of claim 8, the method further comprising the steps of displaying the adaptive training session to the user using a graphical user interface, and prompting the user to complete the adaptive training session.
